(19) United States
(12) Patent Application Publication
(10) Pub. No.: US 2012/0186837 A1
(43) Pub. Date: Jul. 26, 2012

(54) FIREFIGHTING ATTACHMENT FOR AN EXCAVATOR AND METHOD FOR USING THE SAME

(76) Inventor: Philip Paull, Noblesville, IN (US)

(21) Appl. No.: 13/195,499

(22) Filed: Aug. 1, 2011

Related U.S. Application Data
(60) Provisional application No. 61/369,727, filed on Aug. 1, 2010.

(51) Int. Cl. A62C 27/00

(52) U.S. Cl. 169/52

(57) ABSTRACT

A back hoe attachment for insertion into a burning structure for delivering a water spray, including an elongated hollow tube portion having a tube distal end and a tube proximal end, an elongated blade portion connected to the elongated hollow tube portion and disposed generally parallel to the elongated blade hollow tube portion, a water hose connection interface connected to the tube proximal end, a water diverting portion operationally connected to the tube distal end, and a back hoe connection interface portion operationally connected to the elongated blade member.

### CROSS-REFERENCE TO RELATED APPLICATIONS

This patent application claims priority to co-pending U.S. Provisional Patent Application Ser. No. 61/369,727, filed on Aug. 1, 2011.

### TECHNICAL FIELD

The present novel technology relates generally to the field of mechanical engineering, and, more particularly, to an apparatus for enabling an excavator or backhoe to inject water into the hot spot of a burning building structure, and a method for using the same.

### BACKGROUND

Despite improvements in building materials and design, fires in both residential and commercial structures tend to spread fast and cause tremendous damage. A good deal of the damage caused by fires arises from the attempts made to extinguish them. Firefighters often spray water into a building from the top in order to contain the fire and push it back down toward the lower levels. This technique also reduces the risk of the fire spreading to an adjacent building. However, the weight of the water on the upper floors typically causes them to collapse into and through the lower floors, and the water itself tends to pool and accumulate in the lower levels, especially the basement.

Fire has a tendency to spread along unblocked open spaces, which act as chimneys for the hot smoke and gas. As fires tend to spread into areas of increased oxygen, they may become isolated and hard to reach by firefighters armed with hoses. This problem is compounded in residential structures, since the variety of design of homes is very great. Unlike commercial structures, which tend to be similar in functionally-driven design, home designs may vary greatly, and it is difficult to guess the layout of the home from a brief look at the front. For example, the number and placement of the bedrooms is impossible to accurately determine at a glance and emergency responders must manually search a burning house to make sure all of the rooms are clear. This takes time, and increases the risk of harm to both occupants and firemen.

In addition, the construction type and building materials used also contribute to both the spread and intensity of the fire and the difficulty of getting to the fire to put it out. These factors influence burn rate (and thus the maximum safe time firemen can be in the building), structural integrity, whether or not toxic gasses will be evolved during combustion, and the like. All of these factors influence how long occupants may survive in the structure, which rooms are at greatest risk, how firemen should approach entry, what firefighting techniques may best be applied, and the like.

Thus, there is a need for an apparatus that could apply water directly to fires in a residential or commercial structure while bypassing the relatively untouched and unharmed areas. Further, there is a need for an apparatus that could target the populated areas in a burning structure and apply water to them and to the path between the populated areas and exits to provide relatively safe egress. The present novel technology addresses this need.

### SUMMARY

The present novel technology relates to a method and apparatus for surgically injecting water into a burning structure. One object of the present novel technology is to provide an improved firefighting tool. Related objects and advantages of the present novel technology will be apparent from the following description.

### BRIEF DESCRIPTION OF THE DRAWINGS

FIG. 1 is a side view of a first embodiment of the present novel technology, an elongated member for connection to an excavator for piercing burning buildings and delivering a water spray to fires therein.

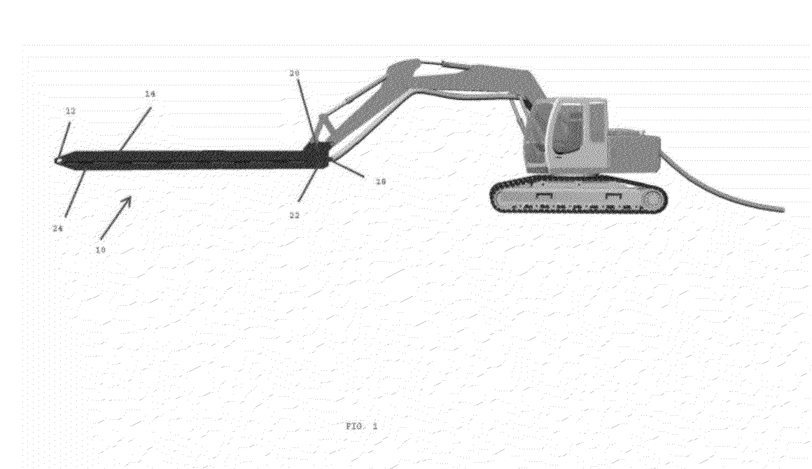

FIG. 2 is a front perspective view of the elongated member of FIG. 1 as connected to an excavator.

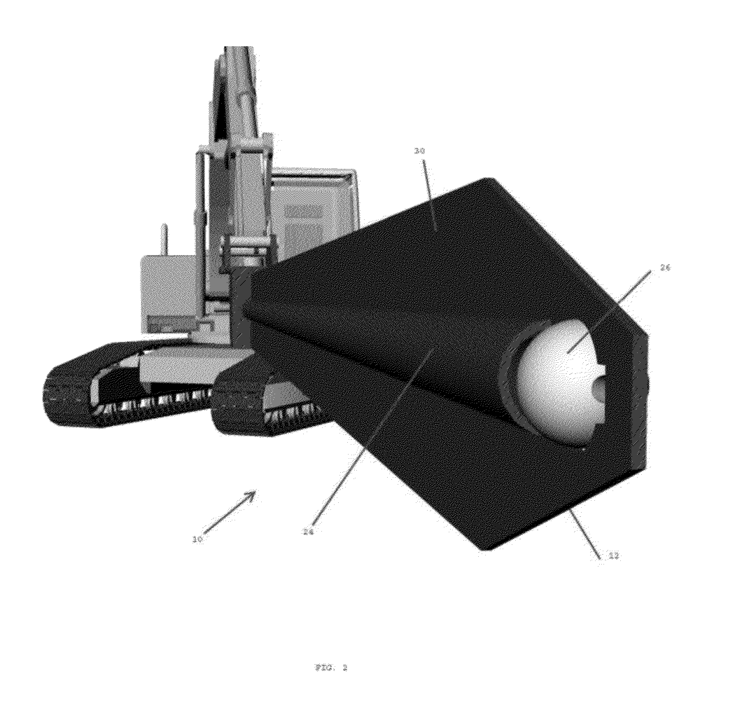

FIG. 3 is an enlarged side perspective view of the elongated member of FIG. 1.

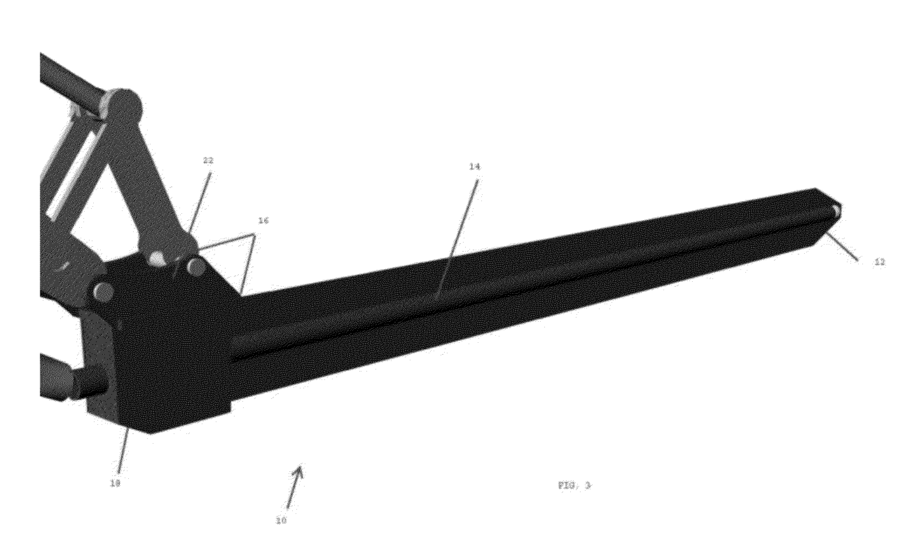

FIG. 4 is an enlarged perspective view of the elongated member of FIG. 1 as connected to an excavator and fire hose.

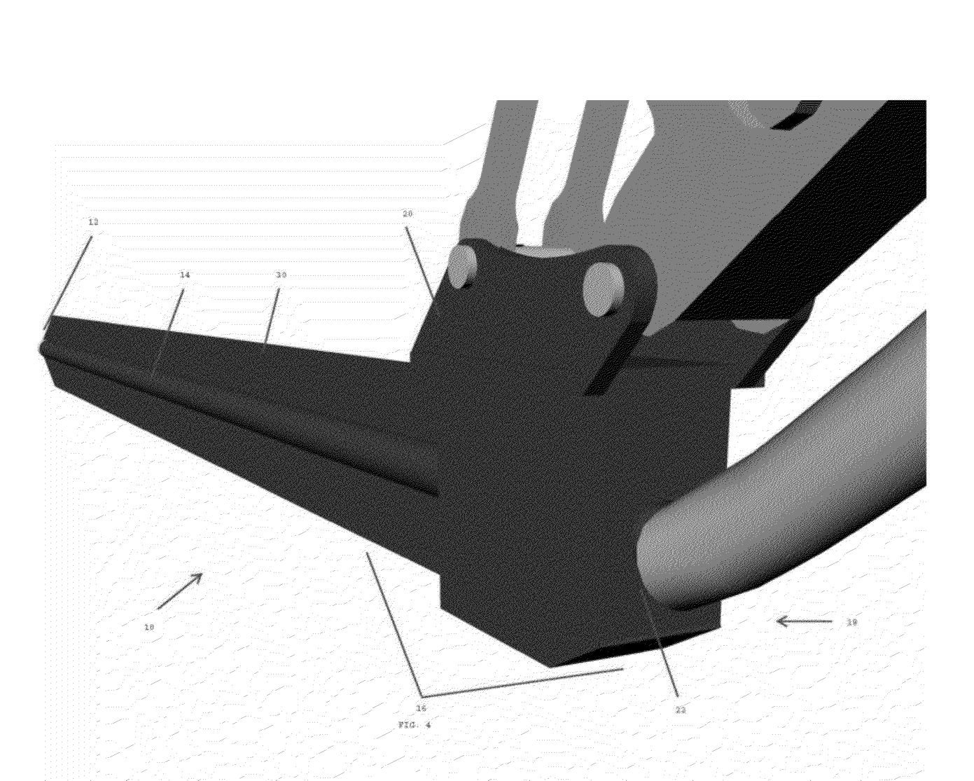

### DETAILED DESCRIPTION OF THE PREFERRED EMBODIMENT

For the purposes of promoting an understanding of the principles of the novel technology and presenting its currently understood best mode of operation, reference will now be made to the embodiments illustrated in the drawings and specific language will be used to describe the same. It will nevertheless be understood that no limitation of the scope of the novel technology is thereby intended, with such alterations and further modifications in the illustrated device and such further applications of the principles of the novel technology as illustrated therein being contemplated as would normally occur to one skilled in the art to which the novel technology relates.

Excavators and backhoes are very versatile digging tools. In addition to maneuverability of the vehicle itself, the articulated boom arm can be positioned to reach into excavations and structures alike. The digging apparatus of the excavator and/or backhoe includes a hinged and hydraulically driven armature to which a generally semicircular bucket is hingedly connected. Backhoe buckets tend to be about 2 feet wide and connect to the manipulating armature at a like-sized connection plate. There are a number of available bucket extensions and attachments, and operators are able to quickly and easily remove one attachment and connect another.

A typical backhoe, trackhoe or like excavator includes a hinged armature or boom having a connection plate or assembly at the far end. The connection assembly typically includes one or more connection members and a set of pins for engaging a bucket. The bucket is typically generally semicircular or semi-ovoid in shape. Buckets are designed to scoop out and retain a maximum load of dirt, gravel or the like. The backhoe operates by driving the teeth or leading edge of the bucket into the dirt or other medium to be excavated or moved, driving the bucket forward to fill it, pivoting the bucket into a mouth-up position, lifting the bucket out of the excavation, pivoting the armature away from the excavation, pivoting the bucket into a mouth-down position, emptying the bucket, pivoting the armature back to the excavation, and repeating the process.

The present novel technology allows for using the power and flexibility of the armature to insert an elongated member 10, having a generally pointed distal end 12, through the exterior wall, as well as through interior walls, floors, ceilings, and the like, of a burning building directly into burning hot spots for delivery of water thereto. The elongated member 10 further includes a hollow tube member or portion 14 extending the length of the member 10. A connection portion 16 is positioned at the proximal end 18 of the elongated member 10. The connection portion 16 includes a mechanical interface 20 for connecting the elongated member 10 to a hoe armature or the like, and a hose connection interface or portion 22 for connecting the hollow tube portion 14 to a standard fire hose. Alternately, the mechanical interface 20 may be connected to a fire truck's hydraulic ladder assembly, a boom arm, or the like.

The distal end 12 of the elongated member 10 includes a sprayer portion 24 operationally connected at or near the distal end of the hollow tube portion 14. The sprayer portion 24 typically includes a water diverting member 26, such as a ball sprayer, positioned to interrupt and divert the flow of water from the tube 14 for producing a water fan from the distal end 12 of the elongated member 10. The sprayer portion 24 may also include an array of apertures (not shown) formed near the distal end 12 of the hollow tube portion 14. Alternately, any convenient sprayer attachment 24 or design may be selected.

The elongated member 10 further includes a structural penetration member 30. Typically, the structural penetration member 30 defines at least one, and more typically two, elongated blade portions 30 for penetrating structural materials such as wood, masonry, concrete and the like. The blade portions typically 30 extend the length of the elongated member and typically flank the elongated tube portion 14 on opposite sides. The blade portions 30 are typically formed from a structural material, such as steel plate. The blade portions 30 typically taper or otherwise generally define a pointed end to concentrate the lateral force of member 10 when engaged against a wall for penetration therethrough.

In other embodiments, the penetration member 30 may be formed as a lance, a ram or the like. The penetration member 30 may be unitary with the elongated tube member 14.

In operation, the elongated member 10 is mechanically connected to a desired hydraulic armature and hydraulically connected to a water supply, such as a fire hydrant, water pump connected to a water tank on a fire truck, or the like. The firetruck, excavator, or the like is positioned adjacent the burning structure, and the armature is energized to actuate insertion of the elongated member 10 into the burning structure through an exterior wall or roof. Once the distal end 12 of the elongated member 10 penetrates into a hot spot or other area desired to be cooled, water is pumped through the hollow tube and applied to extinguish the fire or clear a path for evacuees. In other words, the elongated member or spear 10 is surgically inserted into a burning building to directly apply high pressure water to a fire for quick extinguishment. The operation is repeated as necessary to quickly and efficiently extinguish the major fires burning in the structure without inflicting excessive damage to the structure. Once this is accomplished, firefighters may enter the structure to finish extinguishing the fire and/or rescuing trapped people or artifacts. As the insertion of the elongated member 10 results in a relatively small and narrow slit or opening formed through the exterior and interior walls of the building, minimal structural damage is incurred, resulting in less damage to the structure itself, a greater likelihood of saving the structure, and less danger to the firemen and trapped people in the structure.

In some contemplated embodiments, the placement and insertion of the elongated member 10 is guided by infrared sensors (not shown) to the hottest spots in the burning building. In other embodiments, the elongated member 10 further includes infrared and/or optical sensors (not shown) to allow the operator feedback.

While the novel technology has been illustrated and described in detail in the drawings and foregoing description, the same is to be considered as illustrative and not restrictive in character. It is understood that the embodiments have been shown and described in the foregoing specification in satisfaction of the best mode and enablement requirements. It is understood that one of ordinary skill in the art could readily make a nigh-infinite number of insubstantial changes and modifications to the above-described embodiments and that it would be impractical to attempt to describe all such embodiment variations in the present specification. Accordingly, it is understood that all changes and modifications that come within the spirit of the novel technology are desired to be protected.

I claim:

1. A boom arm attachment for delivering a water spray into a burning structure, comprising:
an elongated penetration member;
an elongated hollow tube member connected to the elongated penetration member;
a water hose connection interface connected to the elongated hollow tube member;
a water diverting member disposed opposite the water hose connection interface and operationally connected to the elongated hollow tube member; and
a mechanical connection interface for connecting to a boom arm operationally connected to the elongated penetration member.

2. The boom arm attachment of claim 1 wherein the mechanical connection interface is compatible for connection to a back hoe boom arm.

3. The boom arm attachment of claim 1 wherein the water diverting member is a ball mounted in the elongated blade member and positioned adjacent the elongated tube member.

4. The boom arm attachment of claim 1 wherein the mechanical connection member is configured to connect to a fire truck ladder assembly.

5. A back hoe attachment for insertion into a burning structure for delivering a water spray, comprising:
an elongated hollow tube portion having a tube distal end and a tube proximal end;
an elongated blade portion connected to the elongated hollow tube portion and disposed generally parallel to the elongated blade hollow tube portion;
a water hose connection interface connected to the tube proximal end;
a water diverting portion operationally connected to the tube distal end; and
a back hoe connection interface portion operationally connected to the elongated blade portion.

6. The back hoe attachment of claim 5 wherein the elongated blade portion has a tapered distal end.

7. The back hoe attachment of claim 5 wherein the elongated blade portion includes a first blade member extending from the elongated tube portion and a second blade member disposed opposite the first blade member and extending from the elongated tube portion.

8. A hoe attachment for insertion into a burning structure for delivering a water spray, comprising:
an elongated water channel portion having a distal end and a proximal end;
a penetration portion extending from the elongated water channel portion;
a water hose connection interface connected to the proximal end;
a water diverting portion operationally connected to the distal end; and
a back hoe connection interface portion operationally connected to the elongated water channel.
